(19) United States
(12) Patent Application Publication
(10) Pub. No.: US 2006/0179643 A1
(43) Pub. Date: Aug. 17, 2006

(54) Rechargeable lithium polymer cell and process for the production of rechargeable lithium polymer batteries

(76) Inventors: Herbert Naarmann, Frankenthal (DE); Franz Josef Kruger, Eppstein (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/057,940

(22) Filed: Feb. 15, 2005

(51) Int. Cl. H01M 10/04; H01M 4/58

(52) U.S. Cl. 29/623.3; 29/623.5; 29/623.4; 429/231.95

(57) ABSTRACT

A process for the production of a lithium polymer cell is involves extruding a material mixture for an anode and a mixture for a cathode to form an anode and cathode masses. At least one of the masses is extruded with a mixture of cyclohexanone and methyl ethyl ketone. The anode and cathode masses are laminated onto conductors and joined with an intervening separator to form a lithium polymer cell.

### FIELD OF THE INVENTION

The invention relates to a lithium polymer cell, a lithium polymer battery containing the cell, and processes for their production.

### BACKGROUND OF THE INVENTION

Lithium polymer batteries consist of an anode, cathode and a polymer electrolyte as a separator. The anode, cathode and the separator are brought together such that a composite is formed in which the separator serves as an intermediate layer for the anode/cathode. The composite obtained is then processed into multiple layers. After placing the layers in a housing and polarizing them, a lithium polymer battery is obtained.

Details regarding the manufacture and system are known and can be found in “Handbook of Battery Materials”, editor J. O. Besenhard, Verlag VCH, Weinheim, 1999. Special production processes such as the so-called Bellcore process are described in Lithium Ion Batteries, editors M. Wakihara and O. Yamamoto, Verlag VCH, Weinheim, 1998, page 235 and FIG. 10.9.

Li ion batteries are described in the Handbook of Batteries, 3^{rd} ed., D. Linden, Th. B. Reddy, Mc Graw-Hill 2001, section 35.1-35.9. The definition of “cell” and “battery” are given in section 1.1: “Popular usage considers the ‘battery’ and not the ‘cell’ to be the product that is sold or provided to the ‘user’. In this 3^{rd} edition, the term ‘cell’ will be used when describing the cell component of the battery and its chemistry. The term ‘battery’ will be used when presenting performance characteristics, etc. of the product. Most often, the electrical data is presented on the basis of a single-cell battery. The performance of a multi-cell battery will usually be different than the performance of the individual cells or a single-cell battery”.

Various processes have been used for the production of lithium polymer batteries. In a coating process, a polymer binder for a cathode mass and/or anode mass is dissolved, for example, in 5-10% fluoroelastomer homopolymer or copolymer in N-methylpyrrolidone (NMP). Cathode-specific and/or anode-specific additives such as lithium-intercalatable metal oxides and/or lithium-intercalatable carbons (carbon black, graphite and similar substances) are added to the polymer solution thus formed. The polymer solution is then dispersed. The dispersion is then applied to current collectors (foils, strips, networks, etc.) using a coating technique.

A variation of the above-described coating process uses aqueous polymer dispersions instead of polymer solutions containing organic solvents.

The so-called “Bellcore process” is a further variation of the coating processes described above. According to the Bellcore process, a component (e.g., dibutyl phthalate, DBP) is also incorporated into the anode mass and/or cathode mass. The component is removed by dissolution from the anode/cathode/separator in order to create sufficient porosity, that is, sufficient absorption capacity, for the supporting electrolyte solution to be added, and to provide migration paths for anions and cations during charging and discharging.

After drying, the coatings obtained by the above processes are processed into prismatic cells or wound cells. A separator, such as separator formed from polypropylene or polyethylene (e.g., Celgard®, Celgard Inc., Charlotte, N.C.) or similar substance with porous structures, is used as an intermediate layer. The system thus produced is placed into a housing and filled with supporting electrolyte solution before being closed.

Another process consists of the extrusion of a the separator comprising a polymer gel electrolyte and an electrode (see, e.g., U.S. Pat. No. 4,818,643 and European Patent 0145498B1), or the extrusion of the anode, separator and cathode in extruders connected in parallel, followed by the subsequent union of the three components (see, e.g., U.S. Pat. App. 2004029008).

U.S. Pat. App. 2004029008 discloses an extruder process in which an electrolyte and an electrode mass are jointly extruded jointly. The electrolyte comprises an aprotic solvent and supporting electrolyte.

The word “electrode” as used herein means either an anode or a cathode. Similarly, the expression “electrode mass” means either an anode mass or a cathode mass.

Unless indicated otherwise, “%” means weight percent.

### SUMMARY OF THE INVENTION

A process for the production of a lithium polymer cell is provided. The process comprises:
providing a material mixture for an anode mass and a material mixture for a cathode mass;
separately extruding the anode material mixture and the cathode material mixture to form an anode mass and a cathode mass, at least one of the material mixtures containing a mixture of cyclohexanone and methyl ethyl ketone;
laminating the anode mass onto a first conductor and laminating the cathode mass onto a second conductor, to form an anode and a cathode, respectively;
removing the cyclohexanone and methyl ethyl ketone from the anode, the cathode, or both; and
joining of the anode and the cathode with a separator disposed therebetween to form a lithium polymer cell.

The invention is also directed to a lithium polymer cell produced by the aforesaid process.

The invention is further directed to a process for the production of a lithium polymer battery comprising:
providing a lithium polymer cell produced by the aforesaid process;
winding the lithium polymer cell;
applying electrical contacts to the wound lithium polymer cell by metal spraying;
placing the contacted lithium polymer cell into a housing and welding the cell to the housing;
drying of the lithium polymer cell in the housing;
evacuating of the dried lithium polymer cell;
filling of the evacuated lithium polymer cell with electrolyte and closing the cell; and
charging the cell.

The invention is also directed to a lithium polymer battery produced by the aforesaid process of battery production.

### DESCRIPTION OF THE FIGURES

FIG. 1 shows a plot of the specific capacity as a function of cycle number for a lithium polymer battery according to an embodiment of the present invention.

FIG. 2 shows a plot of the discharge capacity as a function of voltage for an embodiment of the lithium polymer battery of the invention, determined for six different “C rates”. A “C rate” is the ratio of the cell capacity to the cell charging current.

FIG. 3 shows a plot of the discharge capacity as a function of voltage for an embodiment of the lithium polymer battery of the present invention. The discharge capacity was determined at a constant rate of discharge of C/2 for four different temperatures.

FIG. 4 shows a plot of the relationship between the current and the average voltage during discharge at four different temperatures for an embodiment of the lithium polymer battery of the invention.

FIG. 5 shows so-called “Ragone” plots for an embodiment of the lithium polymer battery of the invention, at five different temperatures. The Ragone plot indicates the ratio of specific energy to specific output.

### DETAILED DESCRIPTION OF THE INVENTION

According to the present invention, lithium polymer cells are produced in a series of steps. A material mixture for an anode and a material mixture for a cathode are formed. The material mixtures comprise the necessary components for formation of a lithium polymer cell. For example, the anode material mixture advantageously comprises a natural or synthetic carbon material capable of intercalating with Li. Examples of such Li-intercalatable carbon materials are synthetic or natural graphite, mesocarbon microbeads, globular graphite powder (e.g., SGB series globular graphite powder from SEC Corp., Amagasaki, Hyogo, Japan), and the like. The Li-intercalatable carbon material is preferably present in an amount of 80 to 95 wt. %, based upon the total weight of the anode material. The anode material may also comprise optional battery-specific additives, for example, in a quantity of 1-10% by weight, based on the electrode mass as a whole. The additive may comprise a binder, preferably in the form of a polymer. Such polymers include, for example, polyvinyl pyrrolidone; fluoroelastomers such as polyvinylidene fluoride (PVDF) and vinylidene fluoride/hexafluoropropylene copolymer; and terpolymers composed of tetrafluoroethylene, hexafluoropropylene and vinylidene fluoride (e.g., Dyneon 220® or 340® of 3M Company, St. Paul, Minn.).

The cathode material mixture contains a Li-intercalatable metal oxide, preferably present in an amount of 80 to 95 wt. %, based upon the total weight of the cathode material. In particular, oxides of heavy metals selected from the group of Mn, Ni, Co, Ti, W, Mo and Cr, and are suitable for use as cathode materials. Optional additives, for example in an amount of 1-10% by weight based on the electrode mass as a whole, may be additionally present in the cathode material. The additive may comprise a binder, preferably in the form of a polymer, which may be selected from the same polymer binders as utilized for the anode binder.

According to the present invention, one or both the anode and cathode material mixtures further comprises an amount of a mixture of cyclohexanone and methyl ethyl ketone as a processing aid in extruding the electrode material mixtures into electrode masses. The mixture of cyclohexanone and methyl ethyl ketone is present in the amount of from 5 to 35 wt. %, more preferably from 5 to 30 wt. % (based on the anode or cathode weight). Inclusion of cyclohexanone and methyl ethyl ketone as an additive in the electrode material mixture provides improved flow behaviour during extrusion.

Any ratio of cyclohexanone to methyl ethyl ketone may be utilized. The composition of the mixture advantageously varies from about 1:99 to about 99:1 (volume) cyclohexanone to methyl ethyl ketone, more preferably about 1:1.

For example, an anode and cathode mass are prepared as follows. The materials are first degasified before use under a 10⁻¹ torr vacuum at 50-60° C. For the anode mass, 91% graphite in the form of a 1:1 weight ratio mixture of Meso Carbon Micro Beads (MCMB) (Osaka Gas Co., Ltd., Japan) and graphite powder (SGB-L, Graphitwerke Kropfmuhl AG, Hauzenberg, Germany) are mixed intensively with 1% conductive carbon black (Ensaco 250 Super P, Ensaco GmbH, Waiblingen, Germany), and 8% tetrafluoroethylene /hexafluoropropylene/vinylidene fluoride terpolymer (Dyneon THV 220, 3M Company). To 100 weight parts of the above anode material mixture is added 10 weight parts of a 1:1 volume mixture of cyclohexanone and methyl ethyl ketone under argon protective gas. For the cathode mass, 90% Al-doped LiNiCoOx (H.C. Stark, TODA) is stirred intensively with 2% conductive carbon black (Ensaco 250, Super P) and 8% tetrafluoroethylene/hexafluoropropylene /vinylidene fluoride terpolymer (Dyneon THV 220). To 100 weight parts of the above anode material mixture is added 10 weight parts of a 1:1 volume mixture of cyclohexanone and methyl ethyl ketone under argon protective gas.

One or both of the anode and cathode material mixtures may further comprise an amount of one or more compounds selected from Formula I and Formula II: 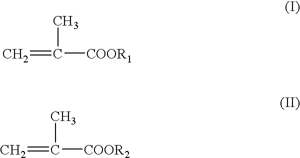
wherein R₁ is selected from the group consisting of C₁ to C₂₀ alkyl, C₂ to C₂₀ alkenyl, C₂ to C₂₀ alkoxy, C₂ to C₂₀ alkoxyalkyl, furfuryl, trimethylsilyl, 3-trimethoxysilylpropyl, and trimethyl(siloxy)ethyl; and R₂ is selected from C₂ to C₂₀ fluorinated alkyl.

By “alkyl”, by itself or as part of another substituent, means a straight, branched or cyclic chain saturated hydrocarbon radical, including di- and multi-radicals, having the number of designated carbon atoms. The expression “C₁-C₂₀ alkyl” thus represents an alkyl chain containing a minimum of 1 carbon atom and a maximum of 20 carbon atoms. Examples include: methyl, ethyl, propyl, isopropyl, butyl, isobutyl, tert-butyl, pentyl, hexyl, and cyclohexyl. The term “alkyl” is intended to embrace “cycloalkyl”, which refers to an alkyl group that contain at least one cyclic structure. Examples include cyclohexyl and isobornyl.

By “fluorinated alkyl” is meant an alkyl group wherein one or more hydrogen atoms is replaced with a fluorine atom.

By “alkoxy” is meant an alkyl group having the designated number of carbon atoms, as defined above, connected to the rest of the molecule via an oxygen atom, such as, for example, methoxy, ethoxy, 1-propoxy, 2-propoxy (isopropoxy) and the higher homologs and isomers.

The term “alkoxyalkyl” means a straight or branched chain radical consisting of one or more alkoxy radicals attached to one or more alkyl moieties. Examples include CH₃—(CH₂)₃—O—CH₂—CH₂—and CH₃—O—CH₂—CH₂—.

The carbon chains in the alkyl, alkenyl, alkoxy, and alkoxyalkyl radicals which may occur in the compounds of Formula I may be cyclic, straight or branched.

Preferred alkyl radicals include methyl, ethyl, n-butyl, iso-butyl, tert. butyl, cyclohexyl, cyclohexyl, dodecyl, isododecyl, ethylhexyl, isobornyl, and octadecyl. Preferred alkenyl radicals include 2-propenyl and ethenyl. Preferred alkoxyalkyl radicals include 2-butoxyethyl, 2-ethoxyethoxyethyl, 2-ethoxylethyl, 2-methoxyethoxyethyl, and 2-methoxyethyl.

Preferred fluorinated alkyl groups are selected from the group consisting of dodecafluoro-7-(trifluoromethyl)-octyl, eicosafluoro-11-(trifluoromethyl)dodecyl, heptafluorobutyl, hexadecafluorononyl, hexafluorobutyl, hexafluoroisopropyl, nonofluorohexyl, octafluoro 5-(trifluoromethyl)-hexyl, pentafluoropropyl, tetrafluoropropyl, tridecafluorooctyl and trifluoroethyl.

The formulae of the radicals R₁ and R₂, along with the boiling points of the corresponding compounds of Formulae I and II, are set forth in Tables 1 and 2, respectively. For some compounds, the pressure at which the boiling point is stated is provided, e.g. “60/43 mm”, meaning 60° C. at a pressure of 43 mm of mercury. Otherwise, the boiling point is stated at standard pressure, 760 mm of mercury.

TABLE 1
R₁ Radicals and Formula I Compound Boiling Points

| | | Formula I Compound | |
|---|---|---|---|
| R₁ Radical name | R₁ Radical formula | Boiling Point (° C.) | |
| 2-propenyl | CH₂═CH—CH₂— | 60/43 | mm |
| 2-butoxyethyl | CH₃—(CH₂)₃—O—CH₂—CH₂— | 104/15 | mm |
| n-butyl | C₄H₉— | 160 | |
| iso-butyl | C₄H₉— | 155 | |
| tert. butyl | C₄H₉— | 132 | |
| cyclohexyl | C₆H₁₁— | 68/4 | mm |
| isododecyl | C₁₀H₂₁— | 126/10 | mm |
| dodecyl | CH₃(CH₂)₁₁— | 142/4 | mm |
| 2-ethoxyethoxyethyl | C₂H₅(CH₂—CH₂O)₂— | 165/4 | mm |
| 2-ethoxylethyl | C₂H₅O—CH₂—CH₂— | 91/35 | mm |
| ethyl | C₂H₅— | 118 | |
| ethylhexyl | CH₃(CH₂)₃(C₂H₅)CH—CH₂— | 120/18 | mm |
| isobornyl | — | 127/15 | mm |
| 2-methoxyethoxyethyl | CH₃(CH₂—CH₂O)— | 98/3.5 | mm |
| 2-methoxyethyl | CH₃—O—CH₂—CH₂— | 65/12 | mm |
| methyl | CH₃— | 100 | |
| octadecyl | CH₃(CH₂)₁₇— | 195/6 | mm |
| 3-trimethoxysilylpropyl | Si(OCH₃)₃—(CH₂)₃— | 190 | |
| trimethylsilyl | Si(CH₃)₃— | 52/20 | mm |
| trimethyl(siloxy)ethyl | Si(CH₃)₃—O—CH₂—CH₂— | 87/18 | mm |
| ethenyl | CH₂═CH— | 111 | |
| furfuryl | — | 80/5 | mm |

TABLE 2
R₁ Radicals and Formula I Compound Boiling Points

| | | Formula II Compound | |
|---|---|---|---|
| R₂ Radical name | R₂ Radical formula | Boiling Point (° C.) | |
| dodecafluoro-7- | (CF₃)₂—CF(CF₂)₄—CH₂—CH₂— | 83/0.85 | mm |
| (trifluoromethyl)-octyl | | | |
| eicosafluoro-11- | (CF₃)₂CF(CF₂)₈CH₂—CH₂— | 110/2 | mm |
| (trifluoromethyl)dodecyl | | | |
| heptafluorobutyl | CF₃—(CF₂)₂—CH₂— | 134 | |
| hexadecafluorononyl | (CF₃)₂—CF—(CF₂)₆—CH₂—CH₂— | 234 | |
| hexafluorobutyl | CF₃—CHF—CF₂—CH₂— | 158 | |
| hexafluoroisopropyl | (CF₃)₂—CH— | 112 | |
| nonofluorohexyl | CF₃(CF₂)₃—CH₂—CH₂— | 60/5 | mm |
| octafluoro-5- | (CF₃)₃CFCF₂CF₂CH₂—CH₂— | 199 | mm |
| (trifluoromethyl)hexyl | | | |
| pentafluoropropyl | CF₃—CF₂—CH₂—CH₂— | 183 | |
| tetrafluoropropyl | CHF₂—CF₂—CH₂—CH₂— | 124 | |
| tridecafluorooctyl | CF₃—(CF₂)₅CH₂—CH₂— | 185/5 | mm |
| trifluoroethyl | CF₃—CH₂— | 60/100 | mm |

The Formula I/II compound is present as a further processing aid in extruding the electrode material mixtures into electrode masses.

The anode and cathode material mixtures are separately extruded to form electrode masses, i.e., an anode mass and a cathode mass. Extrusion may take place, for example, in a double shaft extruder. Other extruder types may be utilized. According to one embodiment of the invention, the anode or cathode material mixture is mixed and kneaded while the cyclohexanone and methyl ethyl ketone mixture is introduced, preferably by a pump operating at, for example, 10-20° C.

For processability of the anode and cathode material mixture to which the cyclohexanone/methyl ethyl ketone additive and optional Formula I/II compound has been included, it is preferred that extrusion of the material mixtures into electrode masses occurs at a temperature of 80-130° C., more preferably 80-120° C., most preferably 80-120° C. In order to increase the material flowability, and to extrude the electrode masses in the most economical and simple manner, it is preferable for the cyclohexanone/methyl ethyl ketone additive to be provided in the electrode mass in the amount of 5 to 35%, preferably 5 to 30%, most preferably in the amount of 10 to 25%, by weight of the electrode mass. Where the electrode is an anode, the amount of the additive is preferably 10 to 25%. Where the electrode is a cathode, the amount of the additive is preferably 15 to 25%.

The Formula I/II compound, if utilized, is preferably present in the amount of from about 0.1 to about 5%, by weight, based upon the combined weight of cyclohexanone and methyl ethyl ketone.

The anode mass and/or the cathode mass are preferably extruded to a layer thickness of 20-90 μm, more preferably 30-90 μm. This thickness range simplifies the subsequent step of laminating the electrode mass to conductors, and provides for increased adhesion between the conductor and the electrode mass. The extrusion output may range from 5 to 50 kg/hour, for example, in a typical process.

The electrode masses are separately laminated to conductors to provide an anode laminate and a cathode laminate. The conductors preferably comprise metal foils. The anode mass and the cathode mass may be directly extruded onto the conductors. Each conductor is typically in the form of a foil, which may be provided as a network, a lattice, or a woven fabric, for example. A copper foil, of thickness 10-20 μm, may be used to form the anode. For the production of the cathodes, aluminium foils are typically employed.

The conductor for the anode is preferably employed without a primer. However, a primer layer may be applied to the cathode conductor to improve conductivity before applying the layer of electrode mass. The primer may comprise, for example, a binder and an electrically conductive carbon compound, carbon black and/or graphite. The carbon compound, carbon black and/or graphite advantageously comprises at least 25% of the primer composition, by weight.

The primer layer may comprise in particular graphite, carbon black, conductive carbon black, Sn powder, borate or silicate filled with carbon black, conductive carbon polymer, or a combination thereof. The proportion of carbon black or Sn may comprise 25-40% by weight, based on the primer, for example. Particularly preferred primer combinations are graphite and Li silicate; conductive carbon black and Li silicate; carbon black and tetrafluoroethylene/hexafluoropropylene/vinylidene fluoride terpolymer; and Sn powder and tetrafluoroethylene/hexafluoropropylene/vinylidene fluoride terpolymer. The tetrafluoroethylene/hexafluoropropylene/vinylidene fluoride terpolymer may comprise, for example, Dyneon THV 200 D® (for use with carbon black) or Dyneon THV 220 D® (for use with Sn powder). Dyneon THV 200 D® and Dyneon THV 220 D® are products of the 3M Company. A preferred primer layer thickness is 20 μm.

The electrode mass and corresponding conductor are laminated together. For maximum adhesion between the conductor and the electrode mass, the lamination is advantageously conducted at temperature in the range of 20° C. to 90° C., preferably in the range of 80° C. to 90° C. The extruded electrode masses are laminated onto both sides of the conductor.

The cyclohexanone and methyl ethyl ketone are carried in the electrode masses through the extrusion step. It is advantageous to remove these additives from the electrode masses after extrusion. A lithium polymer cell from which these additives have been removed adheres better, may be more easily filled with electrolyte, and has better processing properties. Accordingly, to improve electrode mass processability and assist in subsequent cell filling with electrolyte, the cyclohexanone and methyl ethyl ketone are removed from the anode, the cathode, or both, in a removal step. The removal step comprises drying the anode, the cathode, or both. The cyclohexanone and methyl ethyl ketone are preferably reduced to a combined level of less than 1 wt. %, based upon the weight of the electrode mass. Preferably, the amount of cyclohexanone and methyl ethyl ketone is reduced by drying to 0.01 to 0.1 wt. %, based on the weight of the electrode mass. Removal of the cyclohexanone and methyl ethyl ketone may be carried out, for example, by heating the electrode masses to an elevated temperature of up to 180° C., and under vacuum at 10⁻² to 10⁻¹ mm.

After lamination, the electrodes are preferably dried to a surface temperature on the conductor in the range of 120-180° C., for example. Drying assists in the removal of any remaining cyclohexanone and methyl ethyl ketone, and makes it possible to better fill the cells with electrolyte.

The laminates may be optionally calendared to adjust the laminate thickness. Calendering improves electrode quality and substantially reduces internal resistance. The individual electrodes are preferably calendered, for example, at an output speed of 4-5 m/min., which results in 150 meters of electrode output per hour. This material output is sufficient for production of fifty size DD cells per hour.

The anode, consisting of the anode (Cu) conductor coated on both side with the anode mass, and the cathode, consisting of the cathode (Al) coated on both sides with the cathode mass, are then joined. A separator is placed between the anode and cathode. The joined assemblies of anode, separator and cathode are preferably calendered. Calendering of the assembly advantageously takes place at a rate of 5-10 meters/minute. The resulting tri-laminate comprises a lithium polymer cell.

The present invention further relates to a lithium polymer battery and to a process for the production of such a battery. In this respect, the lithium polymer cell is processed into a wound cell or other battery form, such as flat cells, by steps known to those skilled in the art. The steps include winding the cell; releasing the wound cell; applying electrical contacts to the wounds cell, preferably by metal spraying; placing the contacted cell in a housing and welding the cell to the housing; drying the cell in the housing; evacuating the dried cell; filling the evacuated cell with electrolyte; closing the filled cell; and charging the cell. Closure is preferably carried out by riveting. Evacuation of the dried cell and filling with electrolyte should proceed under vacuum. Closure of the electrolyte-filled cell is advantageously carried out by riveting methods known to the art.

The electrolyte may comprise, for example, a Li organoborate and suitable aprotic solvent such as dimethyl glycol, propylene carbonate or similar substance. One such electrolyte comprised LiBF₆ (e.g., 1 _{M}) in diethyl carbonate.

The charging step preferably takes place over a 10 to 24 hour period. In this way, a battery of sufficient capacity and high cycle stability can be obtained. For the same reason, the battery is preferably stored at an elevated temperature, e.g., 60° C., for preferably from 1 to 24 hour, before charging. The latter step ensures that the liquid electrolyte distributed in the battery and wets the contents of the battery.

The resulting lithium polymer battery consists of an anode, cathode and separator, saturated with electrolyte comprising at least one lithium supporting electrolyte and an aprotic solvent.

The lithium polymer battery of the present invention is particularly suitable as a cylindrical battery of the so-called “bobbin” type. An example is a double D cell (DD cell) having a length of 60 to 180 mm.

The practice of the invention is illustrated by the following non-limiting examples. In the following examples, the term “μm” in connection with a foil or film refers to the thickness of that foil for film.

### EXAMPLE 1

### Production of Anode-Separator-Cathode Laminate

Twenty-five kg batches of cathode and anode material were prepared, respectively, as follows. Under vacuum mixer dryer, a cathode material mixture of 23.75 kg of lithium cobalt oxide, 1 kg of Dyneon THV 220® tetrafluoroethylene/hexafluoropropylene/vinylidene fluoride terpolymer (3M Company) and 0.25 kg of acetylene black (Ensaco, The Netherlands) was homogenized for 12 hours at 120° C. and subsequently degasified under vacuum at 10⁻² torr. Under a vacuum mixer dryer, an anode material mixture of 23.5 kg of Meso Carbon Micro Beads (MCMB) and 1.5 kg of Dyneon THV 220® terpolymer was homogenized and dried for 12 hours at 120° C. and degasified as above. To the homogenized and degasified anode material mixture was added 15% by weight of a 1:1 (volume) mixture of cyclohexanone and methyl ethyl ketone at 100° C. in a double screw extruder. The anode material mixture was extruded to form an anode mass in the form of a thermoplastic foil. The thermoplastic foil was then laminated on both sides to a 12μ thickness Cu foil (Gould Electronics, Inc., Eastlake, Ohio), to a layer thickness in the range of 35-45 μm. The cathode mass was prepared in a similar manner, but without addition of cyclohexanone and methyl ethyl ketone, and substituting a primer-coated Al foil for Cu foil. The primer for the latter consisted of 30% Dyneon THV 220% tetrafluoroethylene/hexafluoropropylene/vinylidene fluoride terpolymer (3M Company) and 70% carbon black (Super P, Ensaco). The primer coating thickness was 6-10 microns. The resulting electrodes were dried by heating with infrared radiation to a surface temperature in the range 120-180° C. The dried electrodes were then joined to opposite sides of a Celgard® polypropylene separator and calendered as described in Plastics Extrusion Technology, F. Hensen, editor, Hanser Publishers, New York, N.Y., 1997, p. 373, 384, FIG. 11.5, 11.16. Briefly, the laminate consisting of the anode-separator-cathode assembly was passed between calendaring rolls at a velocity of 7-12 m/minute and a pressure of 30 bar (30×10⁵ Pa).

### EXAMPLE 2

### Production of a Lithium Cell and Battery

Anode-separator-cathode laminates as produced as in Example 1 were wound to obtain lithium polymer cells. Each cell was then contacted by formation of poles by metal spraying, placed in a stainless steel housing, evacuated and filled with 1 _{M} LiBF₆ in diethyl carbonate as an electrolyte. The physical and electrical properties of the resulting lithium polymer batteries are provided in Tables 1 and 2:

TABLE 1
Physical Properties of Lithium Batteries

| | | |
|---|---|---|
| Diameter | 32 | mm |
| Height (without ends) | 150 | mm |
| Weight | 290 | g |
| Volume (without ends) | 115 | cm² |

| | |
|---|---|
| Housing material | stainless steel |

TABLE 2
Electrical Properties of Lithium Batteries

| | | |
|---|---|---|
| Specific output (30 s impulse discharge) | 1600 | W/kg |
| Power density (30 s impulse discharge) | 3800 | W/l |
| Nominal voltage | 3.6 | V |
| Nominal capacity at 0.3 C. | 6 | Ah |
| Specific energy | 75-80 | Wh/kg |
| Energy density | 190-200 | Wh/l |

To form batteries, the cells were charged at a constant current of 0.60 A, up to a potential of 4.2V and subsequently at a constant potential of 4.2V until the current fell to less than 0.12 A. Discharge was carried out at 0.60 A up to a lower voltage limit of 3.0V. Two further cycles were carried out for quality assurance and capacity determination. Charging in the to further cycles was carried out at 1.8 A to 4.2V, at a constant potential until the current fell to less than 0.18 A. Discharge was carried out at 1.8 A up to a final voltage of 3.0V.

### EXAMPLE 4

### Cycle Data Collection

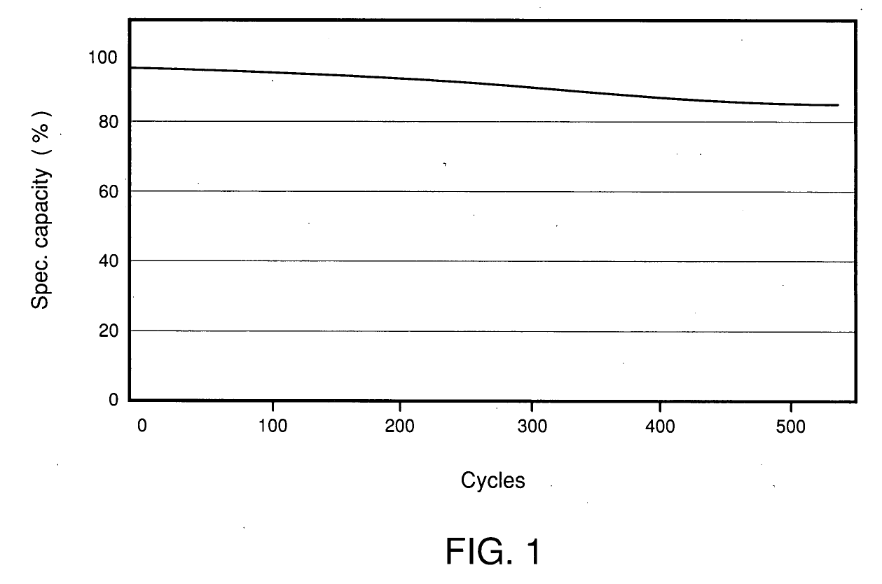

To measure cycle stability, the batteries formed in Example 3 were charged with 3 A to 4.2V, then post-charged in a constant potential phase at 4.2V until the current fell to below 0.3 A. The batteries were discharged at 4.8 A. The lower cut-off voltage was 3.0V. FIG. 1 shows a plot of the specific capacity as a function of the cycle number. As shown in FIG. 1, the battery obtained according to the present invention is characterised by a high cycle consistency, i.e., the specific capacity decreases only slightly over a large number of cycles.

### EXAMPLE 5

### Stress Test at Room Temperature

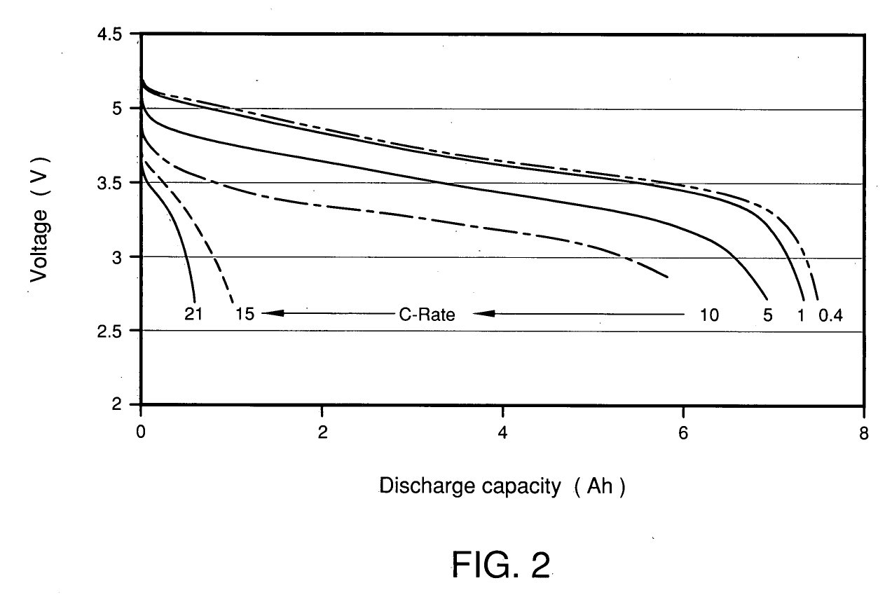

The charging of the formed batteries obtained in Example 4 was carried out at 6 A to 4.2V, with post-charging at a constant potential phase of 4.2V until the current fell to below 0.6 A. The batteries were discharged at different currents between 6 (1 C) and 126 A (21 C). The lower cut-off voltage was 2.7V. FIG. 2 shows a plot of the discharge capacity as a function of the voltage. The discharge capacity/voltage characteristic for six different C rates were determined. A small decrease in voltage value over a wide range of discharge capacity was obtained. This is a desirable characteristic for batteries.

### EXAMPLE 6

### Discharging at Different Temperatures

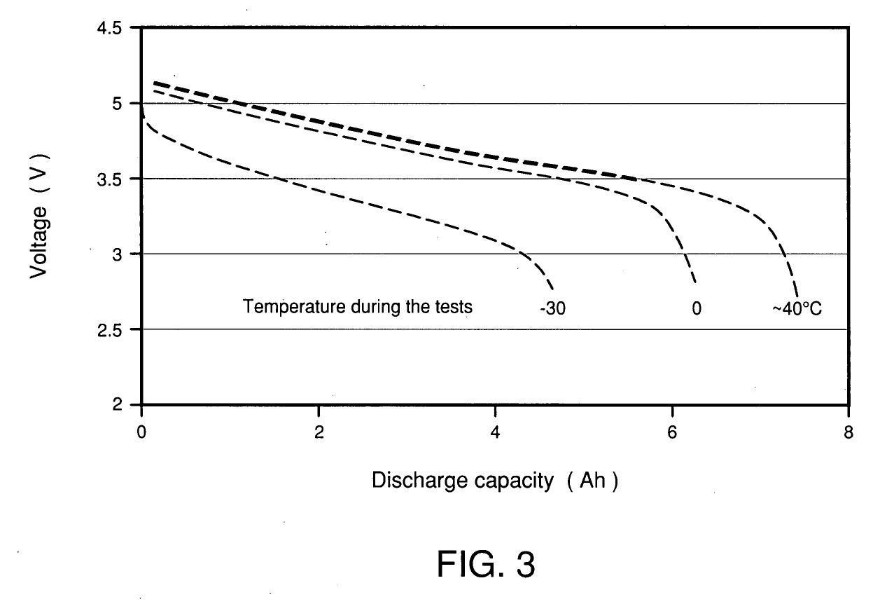

A test was carried out in a manner analogous to Example 5, wherein discharge profiles were measured for different operating temperatures, at a constant discharge rate of C/2. The results are shown in FIG. 3. As in Example 5, the batteries according to the invention exhibited excellent voltage characteristics even at very low and high temperatures.

### EXAMPLE 7

### Stress Test

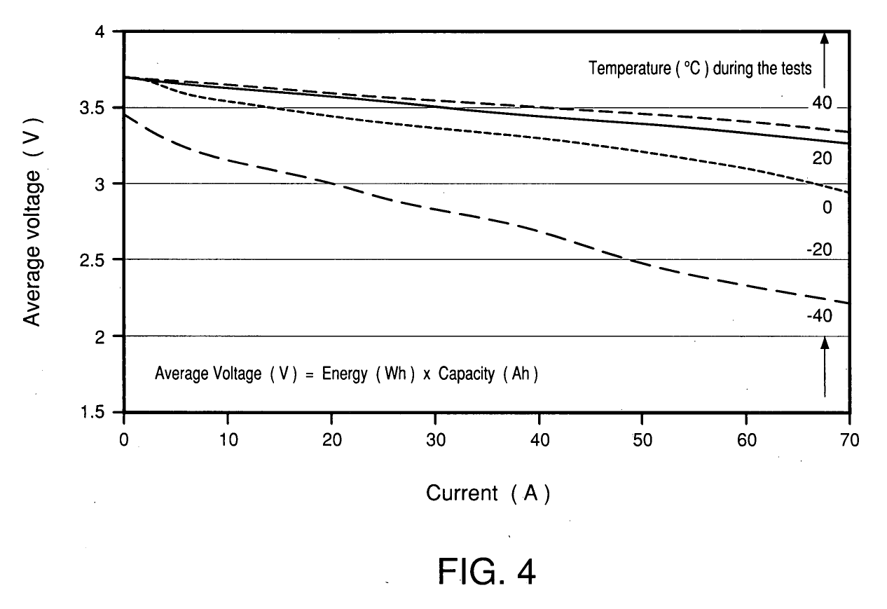

The ratio between the current on the one hand and the average voltage during discharging, on the other hand, was determined for batteries produced as above, for different temperatures. The results shown in FIG. 4 illustrate that average voltage changed only slightly at a high temperature (° C.), over a wide range of current values.

### EXAMPLE 8

### Available Energy content (Ragone plot); Ratio of Specific Energy to Specific Output

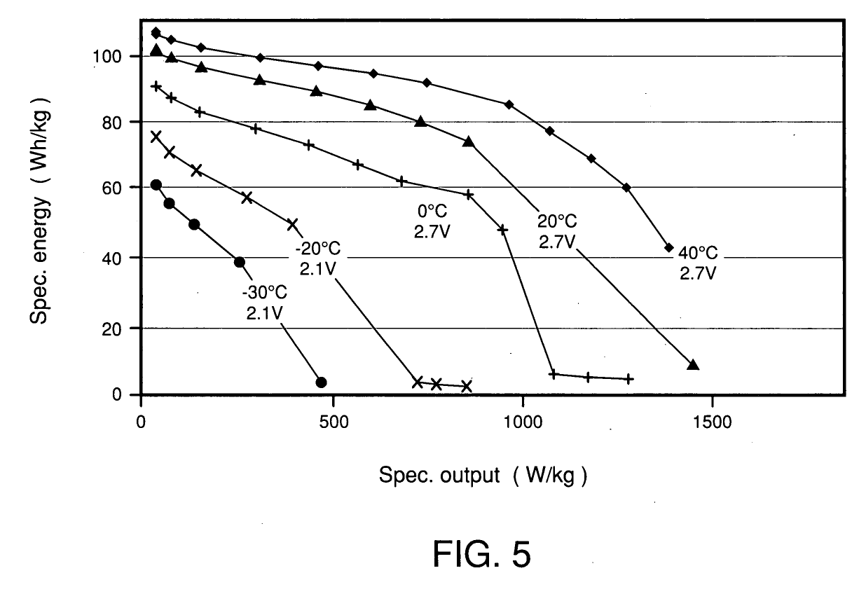

Ragone plots for the batteries prepared as above are presented in FIG. 5. In the lower region of specific energy, only one impulse discharge was possible over a few seconds. The interdependence between the specific energy (in Wh/kg) and the specific output (in W/kg) is indicated in the plots, i.e. the plot displays specific energy (Wh/kg)/specific output (W/kg).

All references discussed herein are incorporated by reference. While the present invention has been described in connection with the preferred embodiments and the various figures, it is to be understood that other similar embodiments may be used or modifications and additions made to the described embodiments for performing the same function of the present invention without deviating therefrom. Therefore, the present invention should not be limited to any single embodiment, but rather should be construed in breadth and scope in accordance with the recitation of the appended claims.

We claim:

1. A process for the production of a lithium polymer cell comprising:
providing a material mixture for an anode mass and a material mixture for a cathode mass;
separately extruding the anode material mixture and the cathode material mixture to form an anode mass and a cathode mass, at least one of the material mixtures containing a mixture of cyclohexanone and methyl ethyl ketone;
laminating the anode mass onto a first conductor and laminating the cathode mass onto a second conductor, to form an anode and a cathode, respectively;
removing the cyclohexanone and methyl ethyl ketone from the anode, the cathode, or both; and
joining of the anode and the cathode with a separator disposed therebetween to form a lithium polymer cell.

2. The process according to claim 1, wherein extrusion of the anode material mixture and the cathode material mixture takes place at a temperature in the range of from 80° C. to 130° C.

3. The process according to claim 1, wherein the anode material mixture, cathode material mixture, or both, comprises from 15 to 35 wt. % of the mixture of cyclohexanone and methyl ethyl ketone, by weight of the cathode or anode mass.

4. The process according to claim 1, wherein the anode material mixture, cathode material mixture, or both, comprises from 15 to 30 wt. % of the mixture of cyclohexanone and methyl ethyl ketone, by weight of the cathode or anode mass.

5. The process according to claim 1, wherein at least one of the material mixtures contains at least one compound of at least one of Formula I or Formula II: 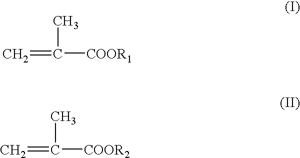
wherein:
R₁ is selected from the group consisting of C₁ to C₂₀ alkyl, C₂ to C₂₀ alkenyl, C₁ to C₂₀ alkoxy, C₂ to C₂₀ alkoxyalkyl, furfuryl, trimethylsilyl, 3-trimethoxysilylpropyl, and trimethyl(siloxy)ethyl; and
R₂ is selected from C₂ to C₂₀ fluorinated alkyl.

6. The process according to claim 5, wherein R₁ is selected from the group consisting of methyl, ethyl, n-butyl, iso-butyl, tert. butyl, cyclohexyl, dodecyl, isododecyl, ethylhexyl, isobornyl, octadecyl, 2-propenyl, ethenyl, 2-butoxyethyl,2-ethoxyethoxyethyl, 2-ethoxylethyl, 2-methoxyethoxyethyl, 2-methoxyethyl, and furfuryl.

7. The process according to claim 5, wherein R₂ is selected from the group consisting of dodecafluoro-7-(trifluoromethyl)-octyl, eicosafluoro-11-(trifluoromethyl)-dodecyl, heptafluorobutyl, hexadecafluorononyl, hexafluorobutyl, hexafluoroisopropyl, nonofluorohexyl, octafluoro-5-(trifluoromethyl)-hexyl, pentafluoropropyl, tetrafluoropropyl, tridecafluorooctyl and trifluoroethyl.

8. The process according to claim 5, wherein the at least one compound of Formula I or Formula II is present in an amount of from about 0.1 to about 5%, by weight, based upon the combined weight of cyclohexanone and methyl ethyl ketone in the material mixture.

9. The process according to claim 1, wherein the step of removing the mixture of cyclohexanone and methyl ethyl ketone comprises drying the anode, the cathode, or both.

10. The process according to claim 9, wherein the mixture of cyclohexanone and methyl ethyl ketone is reduced by drying to less than 1 wt. %, based on the weight of the cathode or anode.

11. The process according to claim 10, wherein the mixture of cyclohexanone and methyl ethyl ketone is reduced by drying to 0.01 to 0.1 wt. %, based on the weight of the cathode or anode.

12. The process according claim 1, wherein the step of removing the cyclohexanone and methyl ethyl ketone comprises heating the anode or cathode masses to a temperatures in the range of 120° C. to 180° C.

13. The process according to claim 1 wherein the anode mass, the cathode mass, or both, is extruded in a layer thickness of 20-90 μm.

14. The process according to claim 1, wherein the first conductor comprises copper and the second conductor comprises aluminium coated with a primer.

15. A lithium polymer cell produced by the process according to claim 1.

16. The process for the production of a lithium polymer battery comprising:
providing a lithium polymer cell produced by the process according to claim 1;
winding the lithium polymer cell;
applying electrical contacts to the wound lithium polymer cell;
placing the contacted lithium polymer cell into a housing and welding the cell to the housing;
drying of the lithium polymer cell in the housing;
evacuating of the dried lithium polymer cell; and
filling of the evacuated lithium polymer cell with electrolyte and closing the cell; and
charging the cell.

17. The process according to claim 16, the cell closing takes place by riveting.

18. The process according to claim 17, wherein charging takes place over a period of from 10 to 24 hours.

19. The process according to claim 17, wherein the cell is allowed to stand for a period of from 1 to 24 hours between closing and charging.

20. A lithium polymer battery produced by the process according to claim 17.
